(19) United States
(12) Patent Application Publication
(10) Pub. No.: US 2026/0159755 A1
(43) Pub. Date: Jun. 11, 2026

(54) COMPOSITION FOR SELECTIVE ETCHING OF SILICON OXIDE

(71) Applicant: KCTECH CO., LTD., Anseong-si (KR)

(72) Inventors: Jun Woo LEE, Pyeongtaek-si (KR); Hyung Pyo HONG, Seongnam-si (KR); Yo Han KIM, Anseong-si (KR)

(73) Assignee: KCTECH CO., LTD., Anseong-si (KR)

(21) Appl. No.: 19/408,638

(22) Filed: Dec. 4, 2025

(30) Foreign Application Priority Data
Dec. 6, 2024 (KR) 10-2024-0180939

(51) Int. Cl. C09K 13/08

(52) U.S. Cl. CPC C09K 13/08

(57) ABSTRACT

The disclosure relates to an etching composition, and more specifically, relates to an etching composition including: an etchant including a fluorine compound, a first inhibitor including an aromatic ring compound having a sulfonyl group or a polymer thereof, and a second inhibitor including a heterocyclic compound having an aromatic ring substituent having 3 to 20 carbon atoms, wherein a pH of the etching composition is 1.5 to 6.

### CROSS-REFERENCE TO RELATED APPLICATIONS

This application claims the benefit of priority under 35 U.S.C. § 119 to Republic of Korea Patent Application No. 10-2024-0180939, filed Dec. 6, 2024, the content of which is incorporated herein by reference in its entirety.

### BACKGROUND

### 1. Field of the Invention

One or more embodiments relate to an etching composition for selectively removing silicon oxide.

### 2. Description of the Related Art

In semiconductor manufacturing processes, in order to manufacture micro semiconductor devices having various functions, introducing two or more types of films having different characteristics onto a substrate to form circuits having complex structures and integrated at high density is essential. Representatively, various films such as a silicon oxide film, a tetra ethoxysilane (TEOS) film, a doped silicon oxide film such as boron phosphor silicate glass (BPSG), a silicon nitride film, a titanium nitride film, and a polysilicon film may be introduced in semiconductor processes. Among these, the silicon oxide film and the silicon nitride film are particularly widely used and perform various roles such as an insulating film, a barrier film, and a stop film, depending on the semiconductor process and device.

A semiconductor etching process is a process of leaving necessary films according to the characteristics of semiconductor devices to be produced among the various films listed above, and removing other unnecessary films. As described above, as semiconductor circuits are highly integrated and intervals between patterns become narrower, an etching process is required that quickly and accurately removes the film to be removed while simultaneously minimizing the effect on other films. Such etching processes are largely divided into a dry etching process and a wet etching process. Among these, the wet etching process is known to have advantages of higher selectivity, better economic efficiency, and faster etching rate compared to dry etching.

When the purpose of the wet etching process is to remove a silicon oxide film, etching is generally performed by including a fluorine (F) compound from which fluorine may be ionized in a composition. Fluorine in the fluorine compound may directly react with SiO₂ in the silicon oxide film to form SiF₄, H₂SiF₆, and the like, thereby removing the silicon oxide film. For example, when silicon (Si) and a silicon oxide film coexist in a semiconductor substrate, since fluorine generally does not react well with pure silicon, the fluorine compound may selectively remove the silicon oxide film. This is also applied to a process of removing a native oxide film immediately before silicon wafer processing. At this time, in order to improve the efficiency of the process to a certain level or higher, a person skilled in the art may consider increasing the removal rate of a silicon oxide film by increasing the concentration of the fluorine compound.

In addition, there are cases where a silicon oxide film and a silicon nitride film coexist in a semiconductor substrate. Among these, the nitride film must remain so that the silicon nitride film performs roles such as metal film protection, pattern film formation, and a stop layer. Unlike pure silicon, the silicon nitride film has a certain degree of reactivity to fluorine. Therefore, there is a problem that if the concentration of the fluorine compound is unconditionally increased to increase the etching process efficiency, the silicon nitride film is inevitably damaged.

Such damage to the silicon nitride film not only deteriorates the quality of the entire semiconductor substrate, but also may cause errors, malfunctions, etc. of devices, including the semiconductor. Additionally, a high concentration of the fluorine compound inevitably poses safety problems during the process. As the scale of facilities increases, the use of a high concentration of the fluorine compound should be avoided as much as possible. Therefore, there is a need to develop an etching composition that maintains the removal rate of a silicon oxide film at a certain level or higher while minimizing damage to a silicon nitride film, and ensures safety in a manufacturing process by not using a high concentration of the fluorine compound.

### SUMMARY

Embodiments provide an etching composition, the etching composition including: an etchant including a fluorine compound, a first inhibitor including an aromatic ring compound having a sulfonyl group or a polymer thereof, and a second inhibitor including a heterocyclic compound having an aromatic ring substituent having 5 to 20 carbon atoms, wherein a pH of the etching composition is 1.5 to 6, thereby efficiently removing a silicon oxide film during an etching process while simultaneously effectively protecting a silicon nitride film.

However, technical goals to be achieved are not limited to those described above, and other goals not mentioned above are clearly understood by one of ordinary skill in the art from the following description.

According to an aspect, there is provided an etching composition, the etching composition including: an etchant including a fluorine compound, a first inhibitor including an aromatic ring compound having a sulfonyl group or a polymer thereof, and a second inhibitor including a heterocyclic compound having an aromatic ring substituent having 3 to 20 carbon atoms, wherein a pH of the etching composition is 1.5 to 6.

The first inhibitor may include a copolymer in which the aromatic ring compound having the sulfonyl group and an organic acid having a carboxyl group are polymerized.

The first inhibitor may include at least one selected from the group consisting of Formulas 1 to 7:

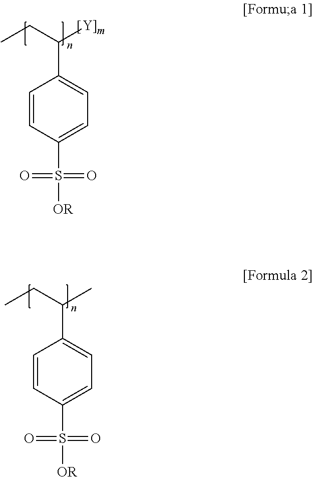

in Formulas 1 and 2,
R is a cation selected from sodium, potassium, hydrogen, and ammonium,
Y is an organic acid having a carboxyl group, and
n and m are each independently an integer of 1 to 10,000,

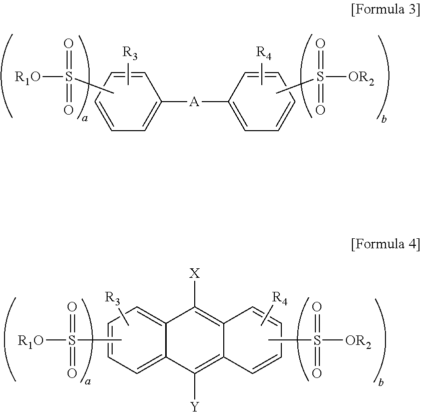

in Formulas 3 and 4,
A is any one selected from a single bond, oxygen (—O—), and a sulfonyl group (—SO₂—),
X and Y are each independently hydrogen or a hydroxyl group,
a and b are each independently an integer of 0 to 2, provided that a and b are not both 0,
R₁ and R₂ are each independently a cation selected from sodium, potassium, hydrogen, and ammonium, and
R₃ and R₄ are each independently any one selected from hydrogen, an alkyl group having 1 to 20 carbon atoms, an alkenyl group having 2 to 20 carbon atoms, an alkyl group having 2 to 20 carbon atoms having a carboxyl group, and a carboxyl group,

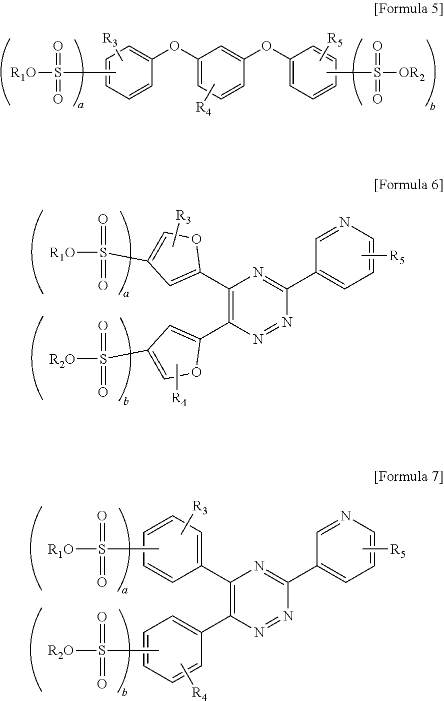

in Formulas 5 to 7,
a and b are each independently an integer of 0 to 2, provided that a and b are not both 0,
R₁ and R₂ are each independently a cation selected from sodium, potassium, hydrogen, and ammonium, and
R₃, R₄, and R₅ are each independently any one selected from hydrogen, an alkyl group having 1 to 20 carbon atoms, an alkenyl group having 2 to 20 carbon atoms, an alkyl group having 2 to 20 carbon atoms having a carboxyl group, and a carboxyl group.

The first inhibitor may include at least one selected from the group consisting of poly(styrenesulfonic acid-co-maleic acid), dodecyl diphenyl ether disulfonic acid, benzeneoxybispropylene sulfonic acid, decyl diphenylsulfone disulfonic acid, lauric acid diphenyl ether disulfonic acid, dodecyl-diphenylsulfone disulfonic acid, dodecyl diphenyl disulfonic acid, dodecylanthracene disulfonic acid, 3-(2-pyridyl,3-dodecyl)-5,6-bis(4-sulfophenyl)-1,2,4-triazine, 1,3-bis(dodecylphenoxylsulfonic acid)benzene, polystyrenesulfonic acid, and salts thereof.

The heterocyclic compound may include one or more of an aromatic heterocycle including at least one selected from the group consisting of pyridine, pyrazine, pyrimidine, pyridazine, triazine, furan, pyrrole, thiophene, imidazole, pyrazole, thiazole, oxazole, isoxazole, quinoline, quinoxaline, quinazoline, cinnoline, phthalazine, benzofuran, indole, benzothiophene, benzimidazole, indazole, benzoxazole, purine, and acridine, and a non-aromatic heterocycle including at least one selected from the group consisting of pyrrolidine, pyrroline, pyrazolidine, imidazolidine, pyrazoline, imidazoline, tetrahydrofuran, dioxalane, tetrahydrothiophene, oxazoline, thiazoline, piperidine, piperazine, tetrahydropyran, thiirane, dioxane, and quinuclidine, wherein the heterocyclic compound may be substituted or unsubstituted with a substituent including at least one selected from the group consisting of an alkyl group having 1 to 20 carbon atoms, an alkyl group having 1 to 20 carbon atoms having an alcohol group, an alkenyl group having 2 to 20 carbon atoms, an alcohol group, and an amine group.

The aromatic ring group may include at least one selected from the group consisting of phenyl, pyridyl, pyrazinyl, pyrimidinyl, pyridazinyl, triazinyl, furanyl, pyrrolyl, thiophenyl, imidazolyl, pyrazolyl, thiazolyl, oxazolyl, isoxazolyl, naphthalenyl, anthracenyl, phenanthrenyl, quinolyl, quinoxalinyl, quinazolinyl, cinnolinyl, phthalazinyl, benzofuranyl, indolyl, benzothiophenyl, benzimidazolyl, indazolyl, purinyl, and acridinyl, wherein the aromatic ring group may be substituted or unsubstituted with a substituent including at least one selected from the group consisting of an alkyl group having 1 to 20 carbon atoms, an alkyl group having 1 to 20 carbon atoms having an alcohol group, an alkenyl group having 2 to 20 carbon atoms, an alkoxy group having 1 to 20 carbon atoms, an alcohol group, an amine group, and a sulfonamide group.

The second inhibitor may include at least one selected from the group consisting of benzylaminopurine, quinine, sulfapyridine, sulfathiazole, phenylimidazole, phenyloxazoline, phenylfuran, phenyloxazole, phenylthiophene, phenylthiazole, omeprazole, 3-phenyl-1H-pyrazole, 4-(3-phenylpropyl) piperidine, pyrilamine maleate, 9,10-bis(4-pyridyl) anthracene, 4-[(E)-2-(9-anthryl) vinyl]pyridine, 4-(naphthalene-2-yl)-1H-imidazopyridine, and 1-[(thiazole-2-yl) azo]-2-naphthol.

The etchant may include at least one selected from the group consisting of hydrofluoric acid (HF), ammonium fluoride (NH₄F), ammonium bifluoride (NH₄HF₂), tetramethylammonium fluoride (NMe₄F), tetrabutylammonium fluoride (NBu₄F), tetrafluoroboric acid (BF₄H), and hexafluorosilicic acid (H₂SiF₆).

The content of the etchant may be 0.1 to 30 weight percent (wt %) based on a total weight of the etching composition.

The content of the first inhibitor and the content of the second inhibitor may be each 0.0001 to 5 wt % based on a total weight of the etching composition.

The etching composition may further include a pH-adjusting agent.

The content of the pH-adjusting agent may be 0.01 to 50 wt % based on a total weight of the etching composition.

The pH-adjusting agent may include at least one selected from the group consisting of an acidic material including at least one selected from the group consisting of hydrochloric acid, sulfuric acid, nitric acid, methanesulfonic acid, p-toluenesulfonic acid, oxalic acid, and sulfamic acid, and a basic material including at least one selected from the group consisting of potassium hydroxide, sodium hydroxide, monoethanolamine, diethanolamine, triethanolamine, tetramethylammonium hydroxide (TMAH), tetraethylammonium hydroxide (TEAH), tetrapropylammonium hydroxide (TPAH), tetrabutylammonium hydroxide (TBAH), tris(2-hydroxyethyl)methylammonium hydroxide (THEMAH), methylamine, ethylamine, propylamine, butylamine, pentylamine, hexylamine, aniline, pyridine, pyrimidine, pyrrole, and imidazole.

A target film to be etched by the etching composition may include a silicon oxide film and a silicon nitride film, wherein the silicon nitride film may include at least one selected from the group consisting of silicon boron nitride (SiBN), silicon carbon nitride (SiCN), silicon nitride (SiN), and silicon oxynitride (SiON).

Additional aspects of embodiments will be set forth in part in the description which follows and, in part, will be apparent from the description, or may be learned by practice of the disclosure.

The etching composition according to an embodiment may include an etchant including a fluorine compound, a first inhibitor including an aromatic ring compound having a sulfonyl group or a polymer thereof, and a second inhibitor including a heterocyclic compound having an aromatic ring substituent having 3 to 20 carbon atoms, wherein the etching composition has a pH of 1.5 to 6, and is characterized in that a silicon oxide film etching rate is secured at a certain level or higher while simultaneously maximizing etching selectivity of a silicon oxide film with respect to a silicon nitride film through interaction of the first and second inhibitors.

The effects of the disclosure are not limited to the above-described effects, and should be understood to include all effects that are inferable from the configurations of the disclosure described in the detailed description or claims of the disclosure.

### DETAILED DESCRIPTION

Hereinafter, embodiments will be described in detail. However, various alterations and modifications may be made to the embodiments. Here, the embodiments are not construed as limited to the disclosure. The embodiments should be understood to include all changes, equivalents, and replacements within the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, the description of embodiments, a detailed description of well-known related structures or functions will be omitted when it is deemed that such a description will cause an ambiguous interpretation of the disclosure.

In addition, the terms first, second, A, B, (a), and (b) may be used to describe components of the embodiments. These terms are used only for the purpose of discriminating one component from another component, and the nature, the sequences, or the orders of the components are not limited by the terms.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

It will be understood that when a certain part “includes” a certain component, the part does not exclude another component but may further include another component.

In addition, in the present specification, the term “compound” is a concept representing a “monomolecular” substance, and may be understood as a concept distinguished from a “polymer”, including a copolymer and the like. Specifically, the “monomolecular” is defined as a substance composed of two or more elements and not including a repeating unit of a certain number of times or more.

On the other hand, a “polymer” is defined as a high molecular weight substance including a repeating unit of a certain number of times or more, may include a “copolymer” including two or more different repeating units, and the repeating unit may include the above-described “monomolecular”.

In addition, the type of the copolymer is not particularly limited, and specifically may include an alternating copolymer, a random copolymer, a block copolymer, and a graft copolymer.

In addition, for any compound A, the term “copolymer of A” may be understood as a concept representing a copolymer having compound A and a compound completely different from compound A as repeating units.

According to an aspect, an etching composition according to an embodiment may be an etching composition including: an etchant including a fluorine compound, a first inhibitor including an aromatic ring compound having a sulfonyl group or a polymer thereof, and a second inhibitor including a heterocyclic compound having an aromatic ring substituent having 3 to 20 carbon atoms, wherein the pH of the etching composition is 1.5 to 6.

The etchant in the etching composition includes a fluorine compound. The fluorine in the fluorine compound is ionized and directly reacts with SiO₂ in a silicon oxide film, removing the silicon oxide film. Thus, the etchant is a core component that enables the etching composition to exhibit its etching property.

On the other hand, the first inhibitor and the second inhibitor are components that protect a silicon nitride film from the fluorine compound or fluorine ions through interaction with the silicon nitride film. For an embodiment according to the disclosure, it was confirmed that the first inhibitor and the second inhibitor satisfy the above conditions and thus perform the role of protecting a silicon nitride film sufficiently. In addition, when both the first inhibitor and the second inhibitor are absent in the composition or only one type of inhibitor is present, it was found that the silicon nitride film cannot be protected from fluorine, or the effect is insignificant. It was confirmed that the first inhibitor and the second inhibitor must exhibit a synergetic effect by interacting with each other to smoothly protect the silicon nitride film, even during an etching process, and through this, it was confirmed that a high etching selectivity of a silicon oxide film with respect to a silicon nitride film may also be implemented.

In addition, even when both the first inhibitor and the second inhibitor are included in the etching composition, it was also confirmed that when the pH of the composition does not satisfy 1.5 to 6, a high etching selectivity of a silicon oxide film with respect to a silicon nitride film as a target cannot be implemented.

According to an embodiment, the pH of the etching composition may be 1.5 to 6.0, preferably 1.5 to 3.5, more preferably 2 to 3.5, still more preferably 2.5 to 3.5, and most preferably 2.5 to 3.0. When deviating from the pH range, the etching reaction itself by the fluorine compound may not proceed properly, and an electrostatic attraction between the first inhibitor and the second inhibitor, or with the silicon nitride film, may not be appropriately generated, resulting in a somewhat reduced silicon nitride film protection effect. In addition, the optimal pH of the etching composition may be changed within the range depending on the type and the content of the etchant, types and content of the first inhibitor and the second inhibitor, and the like.

The first inhibitor includes an aromatic ring compound having a sulfonyl group or a polymer thereof. At this time, the first inhibitor is included in the etching composition of the disclosure, and is presumed to prevent fluorine ions from approaching the silicon nitride film by directly contacting the silicon nitride film through electrostatic attraction with a silicon nitride film, such as SiBN or SiCN, during an etching process to form a first passivation layer.

At least one sulfonyl group must be included in the structure of the first inhibitor, and in some cases, two or more thereof may be included.

The aromatic ring compound is a concept including an aromatic hydrocarbon ring compound and an aromatic heterocyclic compound, and may include not only monocyclic aromatic ring compounds such as benzene, pyridine, pyrazine, pyrimidine, pyridazine, triazine, furan, pyrrole, thiophene, imidazole, pyrazole, thiazole, oxazole, and isoxazole, but also polycyclic aromatic ring compounds such as naphthalene, anthracene, phenanthrene, quinoline, quinoxaline, quinazoline, cinnoline, phthalazine, benzofuran, indole, benzothiophene, benzimidazole, indazole, benzoxazole, purine, and acridine. In addition, the aromatic ring compound may include those in which these aromatic ring structures are substituted with a substituent such as an alkyl group having 1 to 20 carbon atoms, an alkenyl group having 2 to 20 carbon atoms, an alkyl group having 2 to 20 carbon atoms having a carboxyl group, or a carboxyl group.

The aromatic ring compound may have 3 to 20 carbon atoms, 4 to 20 carbon atoms, 5 to 20 carbon atoms, or 6 to 20 carbon atoms.

The aromatic ring compound may include a compound in which a plurality of aromatic ring compounds that are the same as or different from each other are connected by a covalent bond, or are connected through an alkylene group (—(CH₂)ₙ—), nitrogen (—NH—), oxygen (—O—), a sulfonyl group (—SO₂—), or the like.

According to an embodiment, the first inhibitor may include a copolymer in which the aromatic ring compound having a sulfonyl group and an organic acid having a carboxyl group are polymerized.

The organic acid having a carboxyl group may include at least one selected from the group consisting of maleic acid, acrylic acid, crotonic acid, cinnamic acid, fumaric acid, and methacrylic acid, and preferably may include maleic acid.

According to an embodiment, the first inhibitor may include at least one selected from the group consisting of the following Formulas 1 to 7. The following Formulas 1 to 7 are merely listing representative specific examples of the first inhibitor, and the structure of the first inhibitor is not necessarily limited thereto.

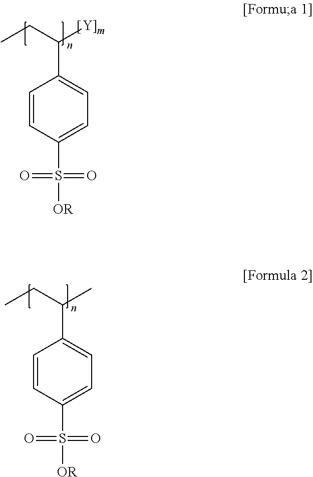

In Formulas 1 and 2,
R is a cation selected from sodium, potassium, hydrogen, and ammonium,
Y is an organic acid having a carboxyl group, and
n and m are each independently an integer of 1 to 10,000,

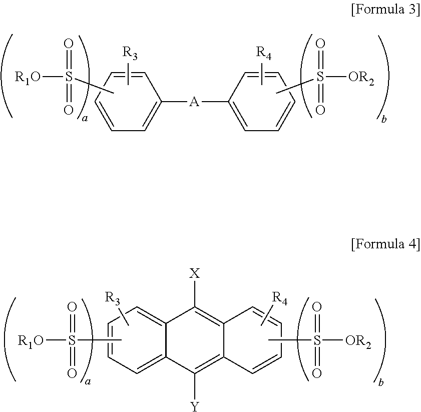

in Formulas 3 and 4,
A is any one selected from a single bond, oxygen (—O—), and a sulfonyl group (—SO₂—),
X and Y are each independently hydrogen or a hydroxyl group,
a and b are each independently an integer of 0 to 2, provided that a and b are not both 0,
R₁ and R₂ are each independently a cation selected from sodium, potassium, hydrogen, and ammonium, and
R₃ and R₄ are each independently any one selected from hydrogen, an alkyl group having 1 to 20 carbon atoms, an alkenyl group having 2 to 20 carbon atoms, an alkyl group having 2 to 20 carbon atoms having a carboxyl group, and a carboxyl group,

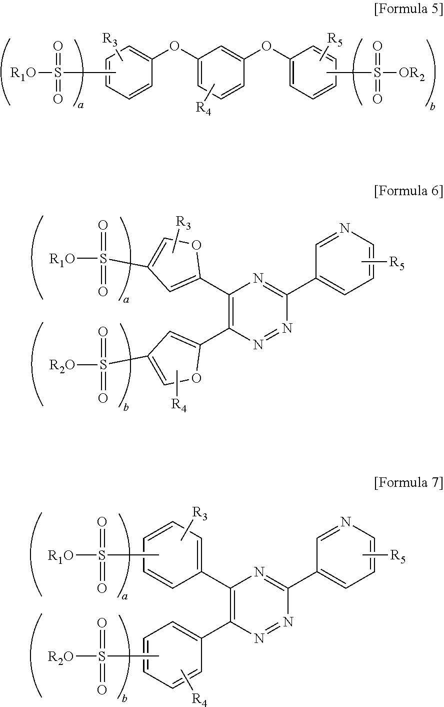

in Formulas 5 to 7,
a and b are each independently an integer of 0 to 2, provided that a and b are not both 0,
R₁ and R₂ are each independently a cation selected from sodium, potassium, hydrogen, and ammonium, and
R₃, R₄, and R₅ are each independently any one selected from hydrogen, an alkyl group having 1 to 20 carbon atoms, an alkenyl group having 2 to 20 carbon atoms, an alkyl group having 2 to 20 carbon atoms having a carboxyl group, and a carboxyl group.

According to an embodiment, the first inhibitor may more specifically include at least one selected from the group consisting of poly(styrenesulfonic acid-co-maleic acid), dodecyl diphenyl ether disulfonic acid, benzeneoxybispropylene sulfonic acid, decyl diphenylsulfone disulfonic acid, lauric acid diphenyl ether disulfonic acid, dodecyl-diphenylsulfone disulfonic acid, dodecyl diphenyl disulfonic acid, dodecylanthracene disulfonic acid, 3-(2-pyridyl,3-dodecyl)-5,6-bis(4-sulfophenyl)-1,2,4-triazine, 1,3-bis(dodecylphenoxylsulfonic acid)benzene, polystyrenesulfonic acid, and salts thereof, and preferably may include at least one selected from the group consisting of poly(styrenesulfonic acid-co-maleic acid), lauric acid diphenyl ether disulfonic acid, dodecyl-diphenylsulfone disulfonic acid, dodecylanthracene disulfonic acid, decyl diphenylsulfone disulfonic acid, and salts thereof.

The second inhibitor includes a heterocyclic compound substituted with an aromatic ring group having 3 to 20 carbon atoms. At this time, the second inhibitor is presumed to perform a role of further improving the protective effect of a silicon nitride film while simultaneously maintaining the entire protection layer more firmly by forming a second passivation layer through a chemical reaction with a first passivation layer formed from the first inhibitor.

The aromatic ring group may have 3 to 20 carbon atoms, 4 to 20 carbon atoms, 5 to 20 carbon atoms, or 6 to 20 carbon atoms.

The heterocyclic compound refers to a compound in which, in a cyclic organic compound in which all elements constituting a skeleton are composed of carbon (C), some of the carbon is substituted with a non-carbon element such as oxygen (O), nitrogen (N), or sulfur(S). In the second inhibitor, it is particularly preferable to have an aromatic ring substituent.

The heterocyclic compound may have 3 to 20 carbon atoms, 4 to 20 carbon atoms, 5 to 20 carbon atoms, or 6 to 20 carbon atoms.

According to an embodiment, the heterocyclic compound may include one or more of an aromatic heterocycle including at least one selected from the group consisting of pyridine, pyrazine, pyrimidine, pyridazine, triazine, furan, pyrrole, thiophene, imidazole, pyrazole, thiazole, oxazole, isoxazole, quinoline, quinoxaline, quinazoline, cinnoline, phthalazine, benzofuran, indole, benzothiophene, benzimidazole, indazole, benzoxazole, purine, and acridine, and a non-aromatic heterocycle including at least one selected from the group consisting of pyrrolidine, pyrroline, pyrazolidine, imidazolidine, pyrazoline, imidazoline, tetrahydrofuran, dioxalane, tetrahydrothiophene, oxazoline, thiazoline, piperidine, piperazine, tetrahydropyran, thiirane, dioxane, and quinuclidine, wherein the heterocyclic compound may be substituted or unsubstituted with a substituent including at least one selected from the group consisting of an alkyl group having 1 to 20 carbon atoms, an alkyl group having 1 to 20 carbon atoms having an alcohol group, an alkenyl group having 2 to 20 carbon atoms, an alcohol group, and an amine group.

According to an embodiment, the aromatic ring substituent may include at least one selected from the group consisting of phenyl, pyridyl, pyrazinyl, pyrimidinyl, pyridazinyl, triazinyl, furanyl, pyrrolyl, thiophenyl, imidazolyl, pyrazolyl, thiazolyl, oxazolyl, isoxazolyl, naphthalenyl, anthracenyl, phenanthrenyl, quinolyl, quinoxalinyl, quinazolinyl, cinnolinyl, phthalazinyl, benzofuranyl, indolyl, benzothiophenyl, benzimidazolyl, indazolyl, purinyl, and acridinyl, wherein the aromatic ring substituent may be substituted or unsubstituted with a substituent including at least one selected from the group consisting of an alkyl group having 1 to 20 carbon atoms, an alkyl group having 1 to 20 carbon atoms having an alcohol group, an alkenyl group having 2 to 20 carbon atoms, an alkoxy group having 1 to 20 carbon atoms, an alcohol group, an amine group, and a sulfonamide group.

The amine group may be a concept including an amine group not bonded to an alkyl group (—NH₂), a primary amine group bonded to an alkyl group having 1 to 20 carbon atoms (—NRH), and a secondary amine group bonded to two alkyl groups having 1 to 20 carbon atoms (—NR₂).

The aromatic ring group may be bonded to a position where hydrogen (—H) of the heterocyclic compound is removed. In a case where the aromatic ring group is in a substituted form, the aromatic ring group may be bound to the heterocyclic compound not only through the aromatic ring but also through a site of the substituent where hydrogen (—H) is removed.

According to an embodiment, the second inhibitor may include at least one selected from the group consisting of benzylaminopurine, quinine, sulfapyridine, sulfathiazole, phenylimidazole, phenyloxazoline, phenylfuran, phenyloxazole, phenylthiophene, phenylthiazole, omeprazole, 3-phenyl-1H-pyrazole, 4-(3-phenylpropyl) piperidine, pyrilamine maleate, 9,10-bis(4-pyridyl) anthracene, 4-[(E)-2-(9-anthryl) vinyl]pyridine, 4-(naphthalene-2-yl)-1H-imidazopyridine, and 1-[(thiazole-2-yl) azo]-2-naphthol, and preferably may include at least one selected from the group consisting of 6-benzylaminopurine, quinine, sulfapyridine, sulfathiazole, 2-phenylimidazole, and 2-phenyl-2-oxazoline.

According to an embodiment, the etchant may include at least one selected from the group consisting of hydrofluoric acid (HF), ammonium fluoride (NH₄F), ammonium bifluoride (NH₄HF₂), tetramethylammonium fluoride (NMe₄F), tetrabutylammonium fluoride (NBu₄F), tetrafluoroboric acid (BF₄H), and hexafluorosilicic acid (H₂SiF₆), and preferably may include at least one of HF and NH₄F. The fluorine compound may be a single composition with respect to the above-mentioned types, but may also be prepared by mixing different types of fluorine compounds.

According to an embodiment, the content of the etchant may be 0.1 to 30 wt % based on the total weight of the etching composition, preferably 0.1 to 20 wt %, more preferably 0.5 to 10 wt %, still more preferably 1 to 10 wt %, and most preferably 2 to 8 wt %.

If the content of the etchant exceeds the range, over-etching may occur even on films that are not etching targets, such as a silicon nitride film, despite the presence of the inhibitor, due to the formation of high-concentration fluorine ions. If the content is less than the range, the etching rate for a silicon oxide film may be excessively reduced, which may rapidly decrease overall process efficiency.

According to an embodiment, the content of the first inhibitor and the content of the second inhibitor may each be 0.0001 to 5 wt % based on the total weight of the etching composition, preferably 0.001 to 3 wt %, more preferably 0.01 to 1 wt %, still more preferably 0.01 to 0.5 wt %, even more preferably 0.01 to 0.3 wt %, and most preferably 0.05 to 0.2 wt %.

If the contents of the first inhibitor and the second inhibitor exceed the range, the etching rate for a silicon oxide film may decrease due to excessive passivation layer formation, and the remaining inhibitors may remain on the silicon oxide film or the nitride film, causing deterioration of electrical properties. If the contents are less than the range, the role of protecting a nitride film may not be properly performed, which may cause damage to the nitride film.

According to an embodiment, the etching composition may further include a pH-adjusting agent.

According to an embodiment, the content of the pH-adjusting agent may be 0.01 to 50 wt % based on the total weight of the etching composition, preferably 0.01 to 40 wt %, more preferably 0.1 to 40 wt %, still more preferably 1 to 30 wt %, even more preferably 1 to 20 wt %, yet more preferably 3 to 20 wt %, and most preferably 10 to 20 wt %. The pH-adjusting agent may be used in an appropriate amount to adjust the pH of the etching composition to a desired pH range.

According to an embodiment, the pH-adjusting agent may include at least one selected from the group consisting of an acidic material including at least one selected from the group consisting of hydrochloric acid, sulfuric acid, nitric acid, methanesulfonic acid, p-toluenesulfonic acid, oxalic acid, and sulfamic acid, and a basic material including at least one selected from the group consisting of potassium hydroxide, sodium hydroxide, monoethanolamine, diethanolamine, triethanolamine, tetramethylammonium hydroxide (TMAH), tetraethylammonium hydroxide (TEAH), tetrapropylammonium hydroxide (TPAH), tetrabutylammonium hydroxide (TBAH), tris (2-hydroxyethyl)methylammonium hydroxide (THEMAH), methylamine, ethylamine, propylamine, butylamine, pentylamine, hexylamine, aniline, pyridine, pyrimidine, pyrrole, and imidazole, and preferably may include methanesulfonic acid. When an acidic material is used as the pH-adjusting agent, it is preferable that the pKa value of an organic acid or an inorganic acid is 3 or less.

According to an embodiment, a target film to be etched by the etching composition may include a silicon oxide film and a silicon nitride film. The silicon nitride film may include at least one selected from the group consisting of silicon boron nitride (SiBN), silicon carbon nitride (SiCN), silicon nitride (SiN), and silicon oxynitride (SiON), and preferably the silicon nitride film may include at least one of SiBN and SiCN. In addition, the silicon oxide film may be understood as a concept including not only an oxide film made of pure silicon dioxide (SiO₂), but also an oxide film in which silicon dioxide is doped with nitrogen (N) or phosphorus (P).

According to an embodiment, the etching rate of the etching composition for a silicon oxide film may be 3,400 Å/min or more, and simultaneously, the etching rate for the silicon nitride film may be 6 Å/min or less. The selectivity of the etching rate of a silicon oxide film with respect to the silicon nitride film may be 500 or more.

According to an embodiment, the etching composition of the disclosure may be used in an etching process for manufacturing a semiconductor device in which silicon oxide coexists with silicon nitride. For example, the etching composition of the disclosure may be used in a wet etching process or a partial wet etching process during a double mold oxide (DMO) or triple mold oxide (TMO) process for manufacturing dynamic random access memory (DRAM).

Specifically, in the DMO process, a nitride film (Mesh) is laminated onto an oxide film (Mold Oxide-2), an upper oxide film (Mold Oxide-1) is laminated again on the oxide film (Mold Oxide-2), and then a hole penetrating all the layers is formed. Thereafter, after applying an electrode material (poly Si, etc.) to the hole, a process of partially etching only the upper oxide film (Mold Oxide-2) is performed. At this time, since a nitride film (Mesh) portion serves as a kind of etch stop layer, an etching solution having high selectivity of an oxide film with respect to a nitride film, such as the composition of the disclosure, is required to proceed with accurate partial etching.

In addition, in the final stage of the DMO process, a process of leaving an electrode portion serving as a capacitor by removing all silicon oxide (SiO₂) components is required. In this case, since the nitride film (Mesh) must remain together with the electrode and perform the role of a structure supporting the electrode, an etching solution having high selectivity of an oxide film with respect to a nitride film, such as the composition of the disclosure, is required.

Hereinafter, the disclosure will be described in more detail through examples. The following examples are described for the purpose of illustrating the disclosure, and the scope of the disclosure is not limited thereto.

### Preparation Example: Etching Composition

After mixing NH₄F and HF as an etchant in a specific ratio, a first inhibitor and/or a second inhibitor to be added according to each comparative example and example composition were combined and added to the etchant mixture. Methanesulfonic acid (CH₄SO₃H) was utilized as a pH-adjusting agent to titrate each composition to a target pH, thereby preparing etching compositions of Comparative Examples 1 to 6 and Examples 1 to 12 (at this time, an appropriate amount of distilled water (DIW) was added to each composition to make the total weight of each composition the same). The types of the first inhibitor and/or the second inhibitor added to each comparative example and example composition, as well as the contents of all components, are summarized and shown in Table 1 below.

TABLE 1

| | | | | | | | pH- | |
|---|---|---|---|---|---|---|---|---|
| | | | | | | | adjusting | |
| | Etchant | | | | | | agent | |
| | NH₄F | HF | First inhibitor | | Second inhibitor | | CH₄SO₃H | |
| | content | content | | Content | | Content | content | |
| | (wt %) | (wt %) | Type | (wt %) | Type | (wt %) | (wt %) | pH |
| Comparative | 1.5 | 4.5 | — | — | — | — | — | 3.6 |
| Example 1 | | | | | | | | |
| Comparative | 1.0 | 2.5 | Poly(Styrenesulfonic | 0.1 | — | — | 0.7 | 3.6 |
| Example 2 | | | acid-co-maleic acid) | | | | | |
| Comparative | 3.0 | 4.5 | Dodecyl | 0.1 | — | — | 12.0 | 2.7 |
| Example 3 | | | diphenyl ether | | | | | |
| | | | disulfonic acid | | | | | |
| Comparative | 1.5 | 4.5 | — | — | 6-Benzyl | 0.1 | — | 3.6 |
| Example 4 | | | | | aminopurine | | | |
| Comparative | 3.0 | 4.5 | Polystyrenesulfonic | 0.1 | — | — | 12.0 | 2.7 |
| Example 5 | | | acid | | | | | |
| Comparative | 6.0 | 4.5 | 1,3- | 0.1 | — | — | 17.5 | 2.7 |
| Example 6 | | | bis(dodecyl | | | | | |
| | | | phenoxylsulfonic | | | | | |
| | | | acid)benzene | | | | | |
| Example 1 | 3.0 | 4.5 | Sodium | 0.1 | 6-Benzyl | 0.1 | 12.0 | 2.7 |
| | | | benzeneoxy | | aminopurine | | | |
| | | | bispropylene | | | | | |
| | | | sulfonate | | | | | |
| Example 2 | 6.0 | 4.5 | Poly(Styrenesulfonic | 0.1 | 6-Benzyl | 0.1 | 17.5 | 2.7 |
| | | | acid-co-maleic acid) | | aminopurine | | | |
| Example 3 | 6.0 | 4.5 | Decyl | 0.1 | Quinine | 0.1 | 17.5 | 2.7 |
| | | | diphenylsulfone | | | | | |
| | | | disulfonic acid | | | | | |
| Example 4 | 6.0 | 4.5 | Lauric acid | 0.1 | 2-Phenyl- | 0.1 | 17.5 | 2.7 |
| | | | diphenyl ether | | 2-oxazoline | | | |
| | | | disulfonic acid | | | | | |
| Example 5 | 6.0 | 4.5 | Dodecyl- | 0.1 | Sulfathiazole | 0.1 | 17.5 | 2.7 |
| | | | diphenylsulfone | | | | | |
| | | | disulfonic acid | | | | | |
| Example 6 | 6.0 | 4.5 | Dodecylantracene | 0.1 | 2-Phenyl | 0.1 | 17.5 | 2.7 |
| | | | disulfonic acid | | imidazole | | | |
| Example 7 | 6.0 | 4.5 | 3-(2-Pyridyl,3- | 0.1 | 6-Benzyl | 0.1 | 38.4 | 2.2 |
| | | | dodecyl)-5,6- | | aminopurine | | | |
| | | | bis(4- | | | | | |
| | | | sulfophenyl)- | | | | | |
| | | | 1,2,4-triazine | | | | | |
| | | | disodium salt | | | | | |
| Example 8 | 6.0 | 4.5 | Poly(Styrenesulfonic | 0.1 | 6-Benzyl | 0.1 | 12.6 | 3.1 |
| | | | acid-co-maleic acid) | | aminopurine | | | |
| Example 9 | 6.0 | 4.5 | Decyl | 0.1 | 6-Benzyl | 0.1 | 7.0 | 3.7 |
| | | | diphenylsulfone | | aminopurine | | | |
| | | | disulfonic acid | | | | | |
| Example 10 | 3.0 | 2.4 | Lauric acid | 0.1 | 6-Benzyl | 0.1 | 5.0 | 4.9 |
| | | | diphenyl ether | | aminopurine | | | |
| | | | disulfonic acid | | | | | |
| Example 11 | 1.5 | 2.4 | Polystyrenesulfonic | 0.1 | 6-Benzyl | 0.1 | 2.0 | 4.5 |
| | | | acid | | aminopurine | | | |
| Example 12 | 17.0 | 2.4 | Dodecylantracene | 0.1 | 6-Benzyline | 0.1 | — | 5.8 |
| | | | disulfonic acid | | aminopurine | | | |

### Experimental Example: Measurement of Etching Performance of Prepared Etching Composition

### (1) Preparation of Test Coupon

Mold oxide (a silicon oxide film doped with N or P), SiBN (a silicon nitride film), and SiCN (a silicon nitride film) were cut into a size of 2*2 cm to prepare test coupons. For the SiBN and SiCN films, after treating the films with 100-fold diluted DHF for 60 seconds, the films were cleaned with DIW for 30 seconds and dried using nitrogen (N₂) gas.

### (2) Measurement of Etching Performance on Test Coupon

Prior to actual etching, the film thickness (pre-film thickness) of the test coupon prepared by the method (1) above was measured in advance using a thin film analyzer (FilmMetrix) or an ellipsometer.

Thereafter, after heating each etching composition prepared by the method of the preparation example to 25° C., each test coupon was immersed in the composition, and an etching reaction was performed for 1 minute. After completing the etching reaction, the test coupons were cleaned with flowing DIW for 30 seconds, and then each test coupon was dried using N₂ gas. After completing the drying process, the film thickness (post-film thickness) of the test coupon that underwent the etching process was measured using a thin film analyzer (FilmMetrix) or an ellipsometer.

Based on the above measurement results, the etch rate for each test coupon was calculated by dividing the difference in film thickness before and after etching (pre-film thickness-post-film thickness) by the processing time (1 minute). Etch rate calculation results for each test coupon of each comparative example and example composition are shown in Table 2 below.

TABLE 2

| | | | | Mold |
|---|---|---|---|---|
| | Etch Rate (Å/min) | | | oxide/SiBN |
| | Mold oxide | SiBN | SiCN | Selectivity |
| Comparative | 2372.3 | 30.9 | 11.9 | 76.8 |
| Example 1 | | | | |
| Comparative | 1460.9 | 11.1 | 2.3 | 131.6 |
| Example 2 | | | | |
| Comparative | 2369.8 | 8.9 | 1.9 | 266.3 |
| Example 3 | | | | |
| Comparative | 2253.7 | 13.0 | 2.7 | 173.4 |
| Example 4 | | | | |
| Comparative | 3558.1 | 9.0 | 2.2 | 395.3 |
| Example 5 | | | | |
| Comparative | 4859.8 | 12.9 | 3.0 | 376.7 |
| Example 6 | | | | |
| Example 1 | 3543.5 | 4.9 | 1.8 | 723.2 |
| Example 2 | 4969.2 | 4.4 | 0.4 | 1129.4 |
| Example 3 | 4758.3 | 4.8 | 1.2 | 991.3 |
| Example 4 | 4822.1 | 4.9 | 0.9 | 984.1 |
| Example 5 | 4799.6 | 4.7 | 0.8 | 1021.2 |
| Example 6 | 4852.3 | 4.5 | 1.1 | 1078.3 |
| Example 7 | 3988.2 | 4.5 | 1.6 | 886.3 |
| Example 8 | 4752.6 | 4.8 | 0.5 | 990.1 |
| Example 9 | 4724.8 | 4.9 | 1.2 | 964.2 |
| Example 10 | 4088.5 | 4.8 | 2.0 | 851.8 |
| Example 11 | 3755.8 | 4.6 | 1.9 | 816.5 |
| Example 12 | 4253.5 | 4.7 | 2.0 | 905.0 |

Reviewing the results in Table 2 based on the contents of Table 1 above, not only when both the first inhibitor and the second inhibitor are not included (Comparative Example 1), but also when one of the first inhibitor and the second inhibitor is not included (Comparative Examples 2 to 6), the etch rate of a mold oxide film is not sufficiently exhibited at 3,400 Å/min or more. Even if the etch rate is sufficiently exhibited, a problem appears in that the etch rate of a SiBN/SiCN nitride film is somewhat high. As a result, it may be confirmed that the etch selectivity of a mold oxide film with respect to a SiBN nitride film is slightly low at less than 500. Therefore, it was found that the etching compositions of the comparative examples are slightly unsuitable for a semiconductor etching process that requires a differential etch rate for each film, while simultaneously including an oxide film layer and a nitride film layer.

On the other hand, the etching compositions of Examples 1 to 12 include an appropriate amount of the first inhibitor and the second inhibitor in various combinations, and the first inhibitor and the second inhibitor cause an interaction with each other so that the etch rate of a mold oxide film exceeds 3,500 Å/min while simultaneously a nitride film etch rate of SiBN and SiCN is exhibited at 6 Å/min or less. As a result, it was found that in all examples, the etch selectivity of a mold oxide film with respect to a SiBN nitride film exhibited a characteristic of exceeding 500.

Accordingly, when “a first inhibitor including an aromatic ring compound having a sulfonyl group or a polymer thereof” and “a second inhibitor including a heterocyclic compound having an aromatic ring substituent” are included in an etching composition, and when the pH range of the etching composition is 1.5 to 6, a composition having an advantageous effect on an etching process due to high selectivity of an oxide film with respect to a nitride film (SiBN, etc.) could be prepared. By utilizing the composition, since an oxide film may be selectively removed from a semiconductor substrate in which an oxide film and a nitride film are simultaneously present, it was confirmed that defects, short circuits, etc. of a semiconductor device occurring due to nitride film damage during a process may be minimized.

While the embodiments have been described, it will be apparent to one of ordinary skill in the art that various alterations and modifications can be made from the above description. For example, suitable results may be achieved if the described techniques are performed in a different order, and/or if the described components are combined in a different manner, and/or replaced or supplemented by other components or their equivalents.

Therefore, other implementations, other embodiments, and equivalents to the claims are also within the scope of the following claims.

What is claimed is:

1. An etching composition comprising:
an etchant comprising a fluorine compound,
a first inhibitor comprising an aromatic ring compound having a sulfonyl group or a polymer thereof, and
a second inhibitor comprising a heterocyclic compound having an aromatic ring substituent having 3 to 20 carbon atoms,
wherein a pH of the etching composition is 1.5 to 6.

2. The etching composition of claim 1, wherein the first inhibitor comprises a copolymer in which the aromatic ring compound having the sulfonyl group and an organic acid having a carboxyl group are polymerized.

3. The etching composition of claim 1, wherein the first inhibitor comprises at least one selected from the group consisting of Formulas 1 to 7: 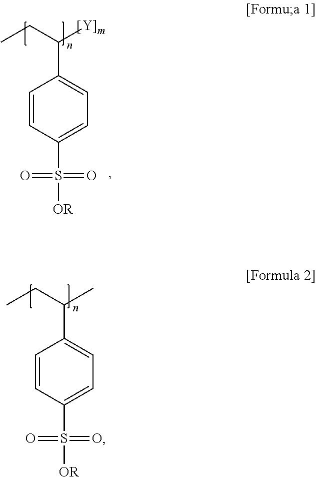
in Formulas 1 and 2,
R is a cation selected from sodium, potassium, hydrogen, and ammonium,
Y is an organic acid having a carboxyl group, and
n and m are each independently an integer of 1 to 10,000, 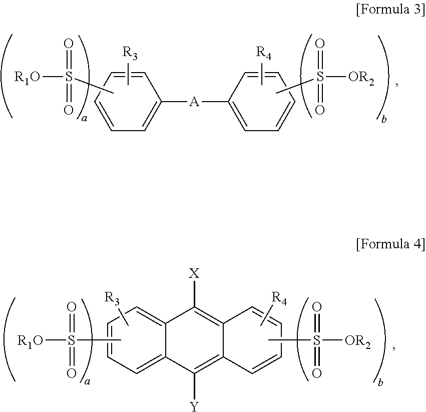
in Formulas 3 and 4,
A is any one selected from a single bond, oxygen (—O—), and a sulfonyl group (—SO₂—),
X and Y are each independently hydrogen or a hydroxyl group,
a and b are each independently an integer of 0 to 2, provided that a and b are not both 0,
R₁ and R₂ are each independently a cation selected from sodium, potassium, hydrogen, and ammonium, and
R₃ and R₄ are each independently any one selected from hydrogen, an alkyl group having 1 to 20 carbon atoms, an alkenyl group having 2 to 20 carbon atoms, an alkyl group having 2 to 20 carbon atoms having a carboxyl group, and a carboxyl group, 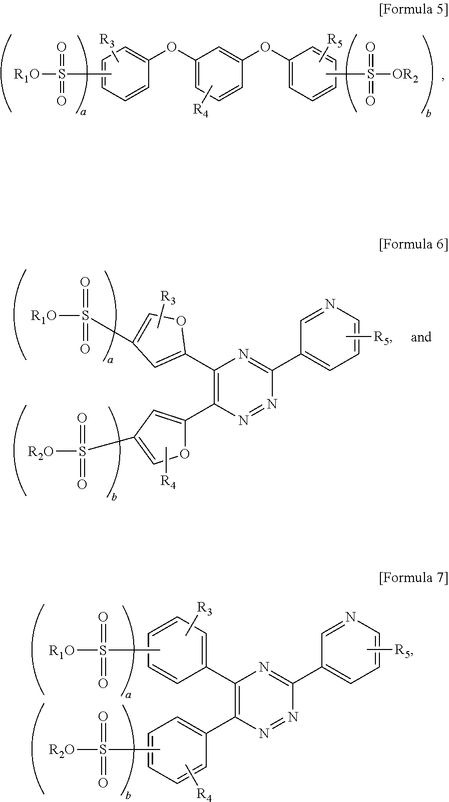
in Formulas 5 to 7,
a and b are each independently an integer of 0 to 2, provided that a and b are not both 0,
R₁ and R₂ are each independently a cation selected from sodium, potassium, hydrogen, and ammonium, and
R₃, R₄, and R₅ are each independently any one selected from hydrogen, an alkyl group having 1 to 20 carbon atoms, an alkenyl group having 2 to 20 carbon atoms, an alkyl group having 2 to 20 carbon atoms having a carboxyl group, and a carboxyl group.

4. The etching composition of claim 1, wherein the first inhibitor comprises at least one selected from the group consisting of poly(styrenesulfonic acid-co-maleic acid), dodecyl diphenyl ether disulfonic acid, benzeneoxybispropylene sulfonic acid, decyl diphenylsulfone disulfonic acid, lauric acid diphenyl ether disulfonic acid, dodecyl-diphenylsulfone disulfonic acid, dodecyl diphenyl disulfonic acid, dodecylanthracene disulfonic acid, 3-(2-pyridyl,3-dodecyl)-5,6-bis(4-sulfophenyl)-1,2,4-triazine, 1,3-bis(dodecylphenoxylsulfonic acid)benzene, polystyrenesulfonic acid, and salts thereof.

5. The etching composition of claim 1, wherein the heterocyclic compound comprises one or more of:
an aromatic heterocycle comprising at least one selected from the group consisting of pyridine, pyrazine, pyrimidine, pyridazine, triazine, furan, pyrrole, thiophene, imidazole, pyrazole, thiazole, oxazole, isoxazole, quinoline, quinoxaline, quinazoline, cinnoline, phthalazine, benzofuran, indole, benzothiophene, benzimidazole, indazole, benzoxazole, purine, and acridine, and
a non-aromatic heterocycle comprising at least one selected from the group consisting of pyrrolidine, pyrroline, pyrazolidine, imidazolidine, pyrazoline, imidazoline, tetrahydrofuran, dioxalane, tetrahydrothiophene, oxazoline, thiazoline, piperidine, piperazine, tetrahydropyran, thiirane, dioxane, and quinuclidine,
wherein the heterocyclic compound is substituted or unsubstituted with a substituent comprising at least one selected from the group consisting of an alkyl group having 1 to 20 carbon atoms, an alkyl group having 1 to 20 carbon atoms having an alcohol group, an alkenyl group having 2 to 20 carbon atoms, an alcohol group, and an amine group.

6. The etching composition of claim 1, wherein
the aromatic ring substituent comprises at least one selected from the group consisting of phenyl, pyridyl, pyrazinyl, pyrimidinyl, pyridazinyl, triazinyl, furanyl, pyrrolyl, thiophenyl, imidazolyl, pyrazolyl, thiazolyl, oxazolyl, isoxazolyl, naphthalenyl, phenanthrenyl, quinolyl, quinoxalinyl, quinazolinyl, cinnolinyl, phthalazinyl, benzofuranyl, indolyl, benzothiophenyl, benzimidazolyl, indazolyl, purinyl, and acridinyl, and
the aromatic ring substituent is substituted or unsubstituted with a substituent comprising at least one selected from the group consisting of an alkyl group having 1 to 20 carbon atoms, an alkyl group having 1 to 20 carbon atoms having an alcohol group, an alkenyl group having 2 to 20 carbon atoms, an alkoxy group having 1 to 20 carbon atoms, an alcohol group, an amine group, and a sulfonamide group.

7. The etching composition of claim 1, wherein the second inhibitor comprises at least one selected from the group consisting of benzylaminopurine, quinine, sulfapyridine, sulfathiazole, phenylimidazole, phenyloxazoline, phenylfuran, phenyloxazole, phenylthiophene, phenylthiazole, omeprazole, 3-phenyl-1H-pyrazole, 4-(3-phenylpropyl) piperidine, pyrilamine maleate, 9,10-bis(4-pyridyl) anthracene, 4-[(E)-2-(9-anthryl) vinyl]pyridine, 4-(naphthalene-2-yl)-1H-imidazopyridine, and 1-[(thiazole-2-yl) azo]-2-naphthol.

8. The etching composition of claim 1, wherein the etchant comprises at least one selected from the group consisting of hydrofluoric acid (HF), ammonium fluoride (NH₄F), ammonium bifluoride (NH₄HF₂), tetramethylammonium fluoride (NMe₄F), tetrabutylammonium fluoride (NBu₄F), tetrafluoroboric acid (BF₄H), and hexafluorosilicic acid (H₂SiF₆).

9. The etching composition of claim 1, wherein a content of the etchant is 0.1 to 30 weight percent (wt %) based on a total weight of the etching composition.

10. The etching composition of claim 1, wherein a content of the first inhibitor and a content of the second inhibitor are each 0.0001 to 5 wt % based on a total weight of the etching composition.

11. The etching composition of claim 1, further comprising a pH-adjusting agent.

12. The etching composition of claim 11, wherein a content of the pH-adjusting agent is 0.01 to 50 wt % based on a total weight of the etching composition.

13. The etching composition of claim 11, wherein the pH-adjusting agent comprises at least one selected from the group consisting of:
an acidic material comprising at least one selected from the group consisting of hydrochloric acid, sulfuric acid, nitric acid, methanesulfonic acid, p-toluenesulfonic acid, oxalic acid, and sulfamic acid, and
a basic material comprising at least one selected from the group consisting of potassium hydroxide, sodium hydroxide, monoethanolamine, diethanolamine, triethanolamine, tetramethylammonium hydroxide (TMAH), tetraethylammonium hydroxide (TEAH), tetrapropylammonium hydroxide (TPAH), tetrabutylammonium hydroxide (TBAH), tris(2-hydroxyethyl)methylammonium hydroxide (THEMAH), methylamine, ethylamine, propylamine, butylamine, pentylamine, hexylamine, aniline, pyridine, pyrimidine, pyrrole, and imidazole.

14. The etching composition of claim 1, wherein
a target film to be etched by the etching composition comprises a silicon oxide film and a silicon nitride film, and
the silicon nitride film comprises at least one selected from the group consisting of silicon boron nitride (SiBN), silicon carbon nitride (SiCN), silicon nitride (SiN), and silicon oxynitride (SiON).
